(19) United States
(12) Patent Application Publication
(10) Pub. No.: US 2006/0157618 A1
(43) Pub. Date: Jul. 20, 2006

(54) Blade gearing structure of air duct of vehicles

(75) Inventor: Hyun-Dong Lee, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/304,682

(22) Filed: Dec. 16, 2005

(30) Foreign Application Priority Data
Jan. 18, 2005 (KR) 2005-4641

(51) Int. Cl. B64C 13/00

(52) U.S. Cl. 244/99.2

(57) ABSTRACT

A blade gearing structure of a vehicle air duct includes a plurality of vertical blades installed in a discharge port of a vehicle instrument panel and cooperating with each other by being connected to each other at regular intervals by a link, a plurality of horizontal blades installed outside the vertical blades and cooperating with each other by being connected to each other at regular intervals by a link, a direction-adjusting knob slidably connected to at least one of the horizontal blades to adjust angles of the horizontal blades and the vertical blades, and a connector that gears the direction-adjusting knob with the vertical blades.

### RELATED APPLICATIONS

The present disclosure relates to subject matter contained in Korea Application No. 10-2005-0004641, filed on Jan. 18, 2005, which is herein expressly incorporated by reference its entirety.

### BACKGROUND OF THE INVENTION

1. Field of the Invention

The present invention relates to a vehicle air duct for discharging air into the passenger compartment of a vehicle, and more particularly, to a blade gearing structure of a vehicle air duct in which a structure for connecting horizontal blades to vertical blades is improved such that the horizontal blades can cooperate with the vertical blades even when the horizontal blades are not perpendicular to the vertical blades and configuration of the blades can be freely designed so that mobility of air flow is enhanced.

2. Description of the Related Art

Generally, vehicles include air conditioners for keeping interior air of the vehicles fresh so as to enhance driver and passenger ride comfort. The vehicle air conditioner includes an air intake port for introducing air into and out of the vehicle, an air duct and a discharge port for discharging the air introduced through the air intake port into the passenger compartment of the vehicle.

FIG. 1 is an exploded perspective view illustrating a conventional vehicle air duct.

The conventional vehicle air duct includes a duct body 10, installed in the discharge port, for guiding purified air into the passenger compartment of the vehicle, a blade unit 30, rotatably installed in the duct body 10, for adjusting the direction of discharged air, and a door 20, rotatably installed in the blade unit 30, for allowing a user to open and close the duct body 10 to adjust the quantity of the discharged air.

Here, the blade unit 30 includes a plurality of vertical blades 32 vertically installed and rotating right and left to determine the right and left directions of the discharged air, a plurality of horizontal blades 34 horizontally installed and rotating upward and downward to determine the upward and downward directions of the discharged air, a direction adjusting knob 36, connected to the vertical blades 32 and the horizontal blades 34 and protruded outside the duct body 10, for allowing the user to selectively rotate the vertical blades 32 or the horizontal blades 34.

Further, the duct body 10 is provided with a quantity adjusting knob 12 that is protruded outside the instrument panel of the vehicle and is connected to the door 20 by means of a plurality of links 14 such that when the driver or a passenger manipulates the quantity adjusting knob 12, the operating force is transmitted to the door 20 and the door 20 rotates to open and close the duct body 10.

The door 20 includes an elastic lip 22 installed to a rim thereof. Since the lip 22 is made of an elastic material such as rubber, the lip 22 can completely seal the duct body 10 to prevent the air discharged from the duct body 10 from leaking when the door 20 is closed.

FIG. 2 is a side view illustrating a connecting structure of the vertical blades and the horizontal blades of the conventional vehicle air duct.

The vertical blades 32 include a concave cut-off part 32a formed in the front intermediate region thereof and a connecting rod 32b vertically installed in the cut-off part 32a. The direction-adjusting knob 36 is installed to the connecting rod 32b to rotate right and left and to slide upward and downward.

Since the horizontal blades 34 are installed to the direction adjusting knob 36 in the horizontal direction, the direction adjusting knob 36 slides in the vertical direction along the connecting rod 32b to adjust the angle of the horizontal blades 34 when the direction adjusting knob 32b is moved in the vertical direction, and the direction adjusting knob 36 slides in the horizontal direction along the horizontal blades 34 to adjust the angle of the vertical blades 32 when the direction adjusting knob 36 is moved in the horizontal direction.

However, according to the conventional blade connecting structure of the vehicle air duct, since vortex is generated when the discharged air passes through the cut-off part 32a due to the cut-off part 32a formed in the vertical blades 32, mobility of the discharged air into the passenger compartment of the vehicle is poor.

Moreover, in the conventional blade connecting structure of the vehicle air duct, since the cut-off part 32a and the connecting rod 32b are installed in the vertical blades 32, the direction adjusting knob 35 slides in the direction perpendicular to the vertical blades 32, and rotates in the horizontal direction, structures of the vertical blades 32 and the direction adjusting knob 36 are complicated. Thus, since the conventional blade gearing structure is not easy to manufacture and assemble, it is difficult to reduce manufacturing time and costs of the conventional vehicle air duct.

Further, in the conventional blade connecting structure of the vehicle air duct, since the horizontal blades 34 are operated, as described above, only when being perpendicular to the vertical blades 32, as shown in FIG. 3, the configuration of the vehicle air duct cannot be freely designed.

### SUMMARY OF THE INVENTION

Therefore, the present invention has been made in view of the above and/or other problems, and it is an object of the present invention to provide a blade gearing structure of a vehicle air duct in which vertical blades are geared with horizontal blades such that structures of the vertical blades and a direction adjusting knob are simply cooperated with each other and various configurations of blades can be designed, mobility of air discharged into the passenger compartment of the vehicle is enhanced, and manufacture and assembly of the air duct are convenient.

In accordance with the present invention, the above and other aspects can be accomplished by the provision of a blade gearing structure of a vehicle air duct including a plurality of vertical blades installed in a discharge port of a vehicle instrument panel and cooperated with each other by being connected to each other at regular intervals by a link, a plurality of horizontal blades installed outside the vertical blades and cooperated with each other by being connected to one of each other at regular intervals by a link, a direction-adjusting knob slidably connected to the horizontal blades to adjust angles of the horizontal blades and the vertical blades, and a connector that gears the direction-adjusting knob with the vertical blades.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is an exploded perspective view illustrating a conventional vehicle air duct;

FIG. 2 is a side view illustrating a connecting structure of the vertical blades and the horizontal blades of the conventional vehicle air duct;

FIG. 3 is a front view illustrating the connecting structure of the vertical blades and the horizontal blades of the conventional vehicle air duct;

FIG. 4 is a perspective view illustrating a blade gearing structure of a vehicle air duct according to a preferred embodiment of the present invention;

FIG. 5 is a perspective view illustrating a first gear of the vehicle air duct according to the preferred embodiment of the present invention;

FIG. 6 is a perspective view illustrating a second gear of the vehicle air duct according to the preferred embodiment of the present invention;

FIG. 7 is a plan view illustrating a blade connector of the vehicle air duct according to the preferred embodiment of the present invention;

FIG. 8 is a side view illustrating the blade connector of the vehicle air duct according to the preferred embodiment of the present invention; and

FIG. 9 is a front view illustrating a blade connector of the vehicle air duct according to another preferred embodiment of the present invention.

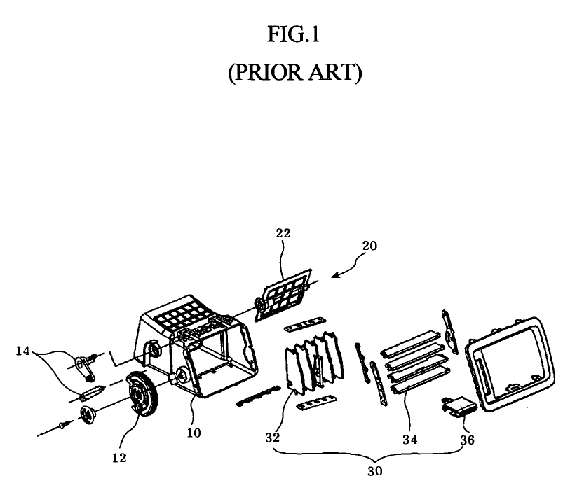

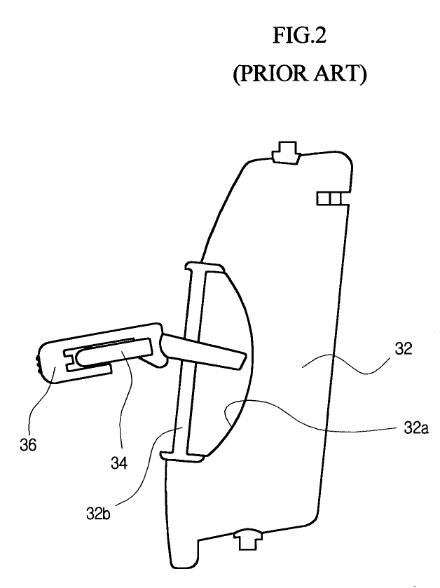

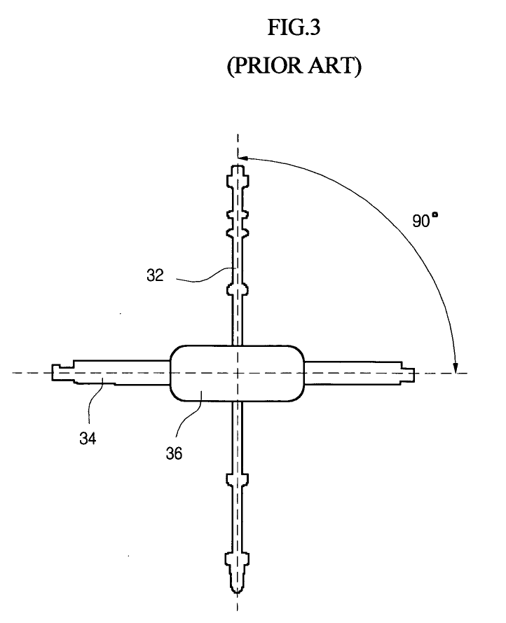

### DESCRIPTION OF THE PREFERRED EMBODIMENTS

Hereinafter, the preferred embodiment of the blade gearing structure of a vehicle air duct according to the present invention will be described in detail with reference to the accompanying drawings.

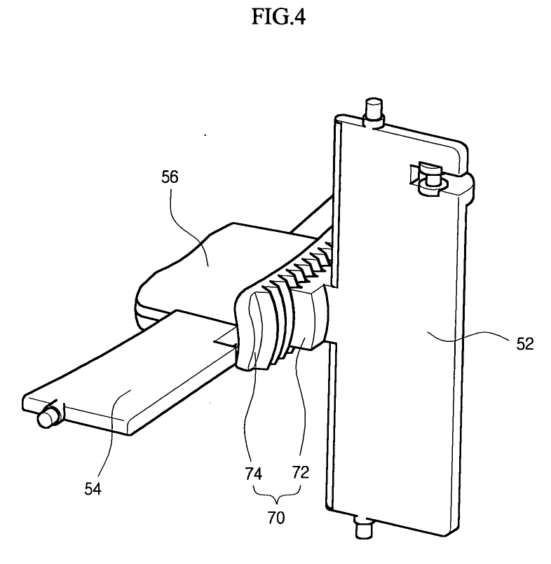

FIG. 4 is a perspective view illustrating a blade gearing structure of a vehicle air duct according to the preferred embodiment of the present invention.

The blade gearing structure according to the preferred embodiment of the present invention includes a plurality of vertical blades 52 that are installed to be connected to each other at regular intervals in the discharge port, formed in the instrument panel of the vehicle, by a link such that the vertical blades 52 are cooperated with each other, a plurality of horizontal blades 54 that are installed to be connected to each other at regular intervals outside the vertical blades 52 by a link such that the horizontal blades 54 cooperate with each other, a direction adjusting knob 56 slidably connected to the horizontal blades 54 to adjust angles of the horizontal and vertical blades 52 and 54, and a connector 70 for gearing the direction adjusting knob 56 with the vertical blades 52 such that the angle of the horizontal blades 54 is adjusted by sliding the direction adjusting knob 56 and the vertical blades 52 with respect to each other when the horizontal blades 54 are operated and the angle of the vertical blades 52 is adjusted by sliding the direction adjusting knob 56 along the horizontal blades 54 when the vertical blades 52 are operated.

Here, the vertical blades 52 are constructed such that the connector 70 is installed to any one of the vertical blades 52 disposed at the central portion so that the vertical blade 52 in which the connector 70 is installed is rotated when the direction adjusting knob 56 is rotated in the horizontal direction by a user and other vertical blades 52 connected to the vertical blade 52 connected to the connector 70 by the link are rotated together to adjust the direction of air discharged into the passenger compartment of the vehicle.

One of the horizontal blades 54 includes a long recess 54a formed at the rear side thereof in the longitudinal direction such that the direction-adjusting knob 56 can be slid. The rear end of the direction-adjusting knob 56 is installed to slide in the recess 54a and the angle of the horizontal blades 54 is adjusted by operating the vertical blades 52 in the vertical direction so that the vertical direction of air discharged through the discharge port is adjusted.

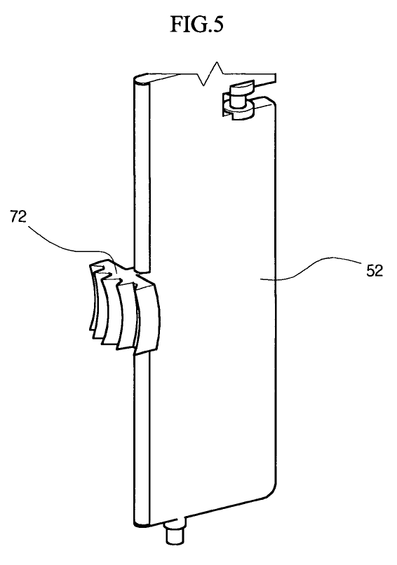

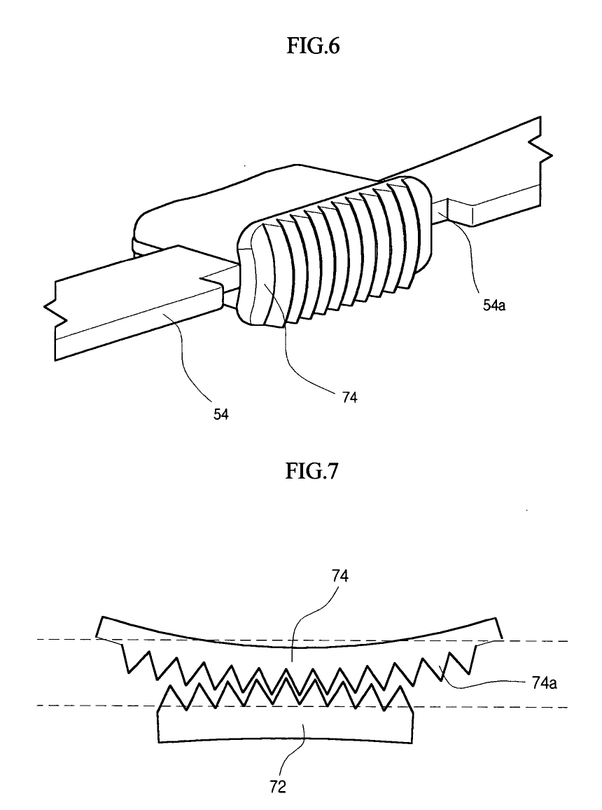

FIG. 5 is a perspective view illustrating a first gear of the vehicle air duct according to the preferred embodiment of the present invention, and FIG. 6 is a perspective view illustrating a second gear of the vehicle air duct according to the preferred embodiment of the present invention.

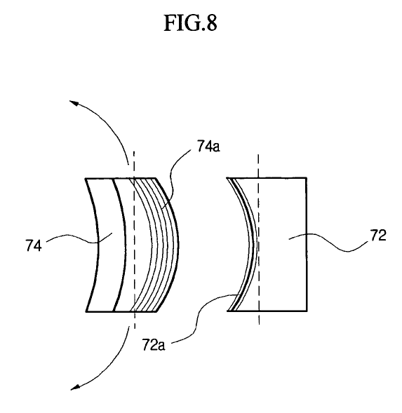

The connector 70 includes a first gear 72 installed in the vertical blades 52 and a second gear 74 installed in the direction-adjusting knob 56 to be geared with the first gear 72. Since the first gear 72 is a rack gear formed in a longitudinal panel, and the second gear 74 has a longitudinal panel shape such that the central portion of the second gear 74 is convexly formed in the plan view and the second gear 74 is geared with the first gear 72 in the rack-and-pinion fashion, the horizontal movement of the first gear 72 causes the angle of the vertical blades 52 to be adjusted when the direction-adjusting knob 56 moves along the horizontal blades 54 on the curved path as shown in FIG. 7.

As shown in FIG. 8, since the central portion of the second gear 74 is convex when seen from the side thereof and the central portion of the first gear 72 is concave when seen from the side thereof such that the first gear 72 is geared with the second gear 74, teeth 74a of the second gear 74 are slid between teeth 72a of the first gear 72 when the direction-adjusting knob 56 in which the second gear 74 is integrally formed is moved vertically, so that the angle of the horizontal blades 54 is adjusted and the vertical direction of air discharged into the passenger compartment of the vehicle is also adjusted.

Operation of the blade gearing structure of the vehicle air duct constructed as above according to the preferred embodiment of the present invention will be described below.

When a driver operates the air conditioner or a heater when traveling, cool or warm air is discharged through the discharge port formed in the instrument panel. In order to adjust the discharging direction of air as the driver or a passenger wishes, the direction-adjusting knob 56 is operated.

At this time, when the user operates the direction-adjusting knob 56 in the horizontal direction, the direction-adjusting knob 56 slides along the horizontal blades 54 while the second gear 74 integrally formed therein moves to the side of the horizontal blades 54, and the first gear 72 geared with the second gear 74 is rotated to adjust the angle of the vertical blades 52 connected to each other by the link such that the horizontal direction of the discharged air is determined.

After that, when the user operates the direction-adjusting knob 56 vertically, the angle of the horizontal blades 54 integrally formed with the direction-adjusting knob 56 and connected to each other by the link is adjusted to adjust the vertical angle of the discharged air.

At this time, since the teeth 74a of the second gear 74, as shown in FIG. 8, are slid between the teeth 72a of the first gear 72a, the vertical blades 52 are not moved when the angle of the horizontal blades 54 is adjusted.

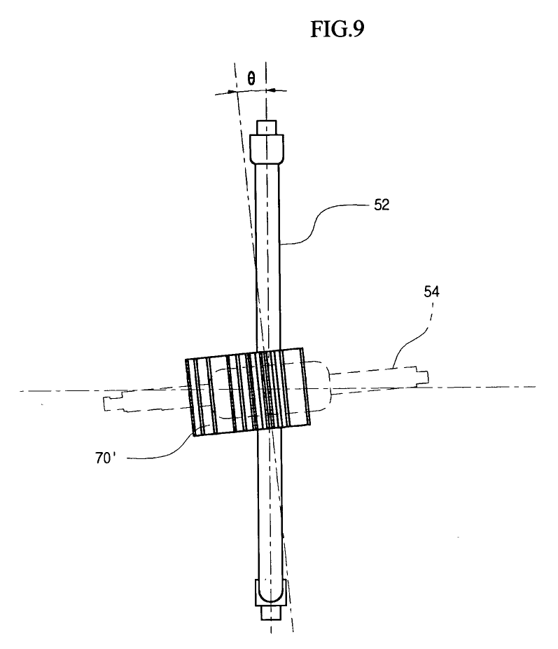

FIG. 9 is a front view illustrating the blade connector of the vehicle air duct according to another preferred embodiment of the present invention.

A blade gearing structure of a vehicle air duct according to another preferred embodiment of the present invention includes identical components such as the vertical blades 52, the horizontal blades 54, and the direction-adjusting knob 56, as shown in FIG. 4. However, a connector 70′ in this embodiment is different from the connector 70 of the preferred embodiment and represents the aspect of another preferred embodiment. The connector 70′ is characterized in that a first gear and a second gear are spaced apart from the vertical blades 52 by a predetermined angle θ such that the horizontal blades 54 cooperate with the vertical blades 52 even when the horizontal blades 54 are not perpendicular to the vertical blades 54.

As such, according to the blade gearing structure of a vehicle air duct according to the present invention, since configuration of the discharge port can be freely designed, the blade gearing structure can be applied to various configured instruments and shapes and configurations of the blades can also be freely designed. Moreover, since the discharge port can be formed at the position of the instrument panel, the mobility of the discharged air can be maximized.

As described above, since the vertical blades are geared with the horizontal blades, the angle of the vertical blades is adjusted by moving the direction-adjusting knob in the horizontal direction and the first and second gears are slid to adjust the angle of the horizontal blades by moving the vertical blades in the vertical direction. Therefore, since none of the members or structures for connecting the vertical blades to the horizontal blades is required, the structure thereof becomes simple, so that time and costs for manufacturing and assembling the vehicle air duct are reduced.

Moreover, since the blade gearing structure of the vehicle air duct becomes simple as described above, vortex is prevented from being generated in air discharged from the discharge port. Thus, the mobility of the discharged air is enhanced.

Further, since the vertical blades are geared with the horizontal blades, the blade gearing structure of the vehicle air duct of the present invention can be operated even when the first gear and the second gear are spaced by a predetermined angle such that various configurations of the blades and the discharge port can be designed. Since the discharge port can be formed at any position of the instrument panel, the mobility of the discharged air is maximized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A blade gearing structure of a vehicle air duct comprising:
a plurality of vertical blades installed in a discharge port of a vehicle instrument panel and cooperating with each other by being connected to each other at regular intervals by a link;
a plurality of horizontal blades installed outside the vertical blades and cooperating with each other by being connected to each other at regular intervals by a link;
a direction-adjusting knob slidably connected to at least one of the horizontal blades to adjust angles of the horizontal blades and the vertical blades; and
a connector that gears the direction-adjusting knob with the vertical blades.

2. The blade gearing structure of a vehicle air duct as set forth in claim 1, wherein the connector is installed in one of the vertical blades disposed at the central portion.

3. The blade gearing structure of a vehicle air duct as set forth in claim 1, wherein the horizontal blades include a longitudinal recess formed at the rear side thereof in the longitudinal direction such that the direction-adjusting knob is slidable.

4. The blade gearing structure of a vehicle air duct as set forth in claim 1, wherein the connector comprises:
a first gear installed in at least one of the vertical blades; and
a second gear installed in the direction-adjusting knob to be geared with the first gear.

5. The blade gearing structure of a vehicle air duct as set forth in claim 4, wherein the first gear comprises a rack gear formed in a longitudinal panel, the second gear is formed in a longitudinal panel shape such that the central portion of the second gear is convexly formed in a plan view and the second gear is geared with the first gear in a rack-and-pinion fashion.

6. The blade gearing structure of a vehicle air duct as set forth in claim 4, wherein the central portion of the second gear is convexly formed in a side view and the central portion of the first gear is concavely formed in the side view to be geared with the second gear.

7. The blade gearing structure of a vehicle air duct as set forth in claim 1, wherein the first gear and the second gear of the connector are spaced apart from the vertical blade at a predetermined angle such that the horizontal blades cooperate with the vertical blades even when the horizontal blade are not perpendicular to the vertical blades.

8. The blade gearing structure of a vehicle air duct as set forth in claim 4, wherein the first gear and the second gear of the connector are spaced apart from the vertical blade by a predetermined angle such that the horizontal blades cooperate with the vertical blades even when the horizontal blades are not perpendicular to the vertical blades.
